(19) United States
(12) Patent Application Publication
(10) Pub. No.: US 2003/0029262 A1
(43) Pub. Date: Feb. 13, 2003

(54) Adjusting worm for a wrench

(76) Inventor: Arthur Wu, Taichung Hsien (TW)

Correspondence Address: BROWDY AND NEIMARK, P.L.L.C., 624 NINTH STREET, NW, SUITE 300, WASHINGTON, DC, 20001-5303, US

(21) Appl. No.: 09/942,848

(22) Filed: Aug. 31, 2001

(30) Foreign Application Priority Data
Aug. 1, 2001 (TW) 90212978

(51) Int. Cl. F16H 1/16

(52) U.S. Cl. 74/425

(57) ABSTRACT

An adjusting worm for a wrench, which has a core with a hole thereof. An outer periphery of the core is provided with a spirally extending tooth. The tooth has two lateral ends respectively having substantially inwardly recessed arcs. Junctures between top ends of the two arcs and top end of the tooth respectively had a fillet such that the two top corners of the tooth are substantially smooth.

### BACKGROUND OF THE INVENTION

(a) Field of the Invention

The present invention relates to a hand tool, more particularly to an adjusting worm for a wrench.

(b) Description of the Prior Art

In the prior art of manufacturing adjusting worms of adjustable wrenches or pipe wrenches, the first step is to form a long worm. Then, the long worm is cut into a number of worms according to a predetermined length. Referring to FIG. 1, an adjusting worm 90 has a tubular core 91, which has a hole 92. The outer side of the core 91 is provided with a spirally extending tooth 93. The two lateral ends of the tooth 93 of the djusting worm 90 are in pointed forms after cutting, and parts of the lateral ends of the tooth 93 have to be removed by milling. After milling, a sharp corner 931 will be left at the top edge at each of the lateral ends of the tooth 93. When an operator turns the adjusting worm 90 with his/her finger (usually the thumb), the sharp corners 931 will make the thumb feel uncomfortable. Although this would not result in physical wound to the operator, however, if the operator's thumb already had a wound, he/she will feel even more uncomfortable by touching the sharp corners 931 with the thumb. The wound may even become worse. All in all, the above is a problem that has been left unresolved in the prior art adjusting worm.

### SUMMARY OF THE INVENTION

The primary object of the present invention is to provide an adjusting worm for a wrench so that when the user turns the adjusting worm with his/her finger, the operator will not feel uncomfortable.

In order to achieve the above-mentioned object of the present invention, the adjusting worm comprises a core centrally provided with a hole, and a spiral-tooth provided on the core. The tooth has two lateral ends with top corners in a smooth form so that the adjusting worm will not make any operator's thumb feel uncomfortable during tuning of the adjusting worm of the present invention.

### BRIEF DESCRIPTION OF THE DRAWINGS

The foregoing and other features and advantages of the present invention will be more clearly understood from the following detailed description and the accompanying drawings, in which,

FIG. 1 is a perspective view of the prior art;

FIG. 2 is a perspective view of the preferred embodiment of the present invention;

FIG. 3 is a side view of the preferred embodiment of the present invention;

FIG. 4 is a schematic view of a adjusting worm having a arc with a smaller curvature radius and a fillet with a larger radius in part; and

FIG. 5 is a schematic view of a adjusting worm having a arc with a larger curvature radius and a fillet with a smaller radius in part.

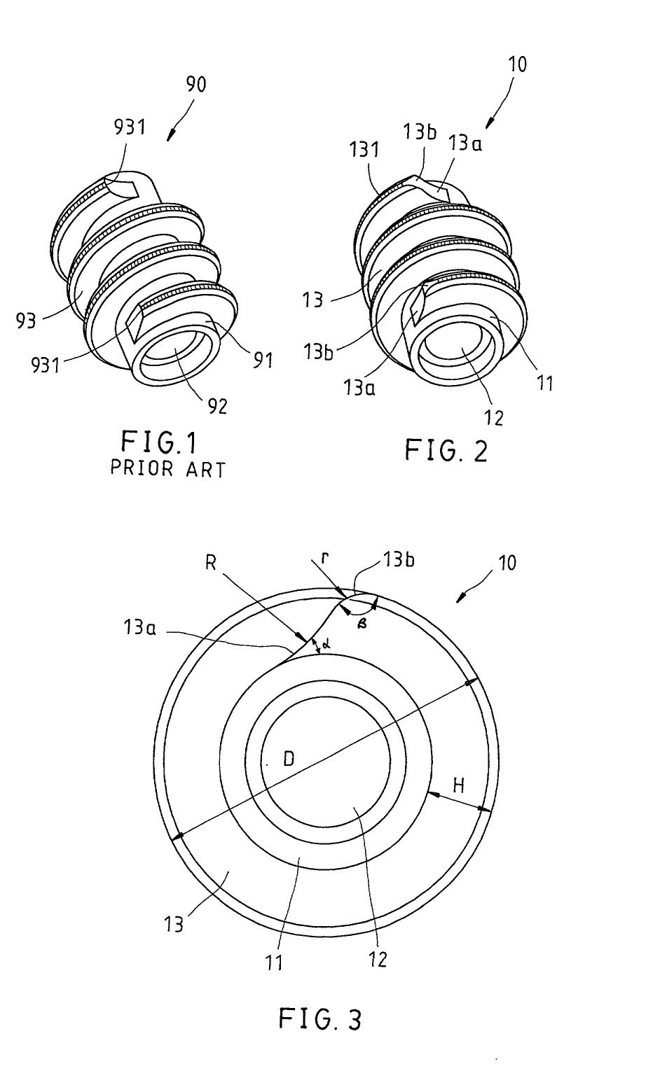

### DETAILED DESCRIPTION OF THE PREFERRED EMBODIMENT

A adjusting worm 10 of the preferred embodiment according to the present invention is mounted on a hand tool, such as an adjustable wrench, a pipe wrench or the like, for driving a movable jaw thereof to displace.

Referring to FIGS. 2 and 3, the adjusting worm 10 includes a tubular core 11, which is centrally formed with a hole 12. A pin (not shown) is that provided through the hole 12 to mount the adjusting worm 10 on a wrench such that the adjusting worm 10 can freely rotate. The outer periphery of the core 11 is provided with a generally spiral tooth 13 with an outer end provided with a vein 131 for facilitating turning of the adjusting worm 10 by the user.

Both lateral ends of the tooth 13 of the adjusting worm 10 had a recessed arc 13a respectively, which were formed by milling. A juncture between the respective arc 13a and the top end of the tooth 13 had a fillet 13b such that the tooth 13 forms a continuous smooth curved surface from the two lateral ends thereof to the top end thereof. Since the two top corners of the tooth 13 are configured to be fillets 13b, when the user turns the adjusting worm 10 and presses the tooth 13 with his/her thumb, the user will not feel uncomfortable.

The adjusting worm 10 according to the present invention can be manufactured by the computer numerical control (CNC) milling machine to control the path of the milling cutter so that the tooth 13 can be milled to form the predetermined arcs 13a and the fillets 13b at a single operation. Certainly, the adjusting worm also can be manufactured in the conventional method described above and then processed to form the fillets 13b in another step. However, the first method will be recommended by the inventor.

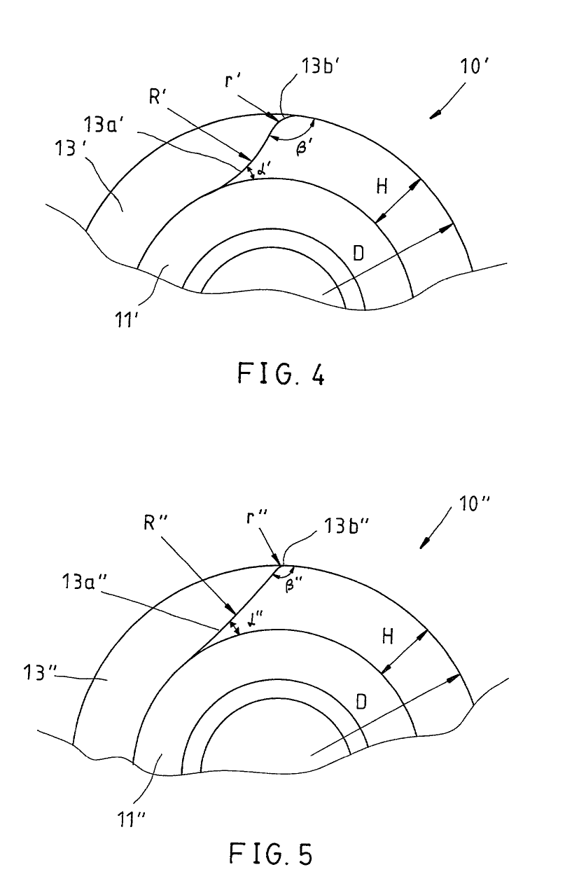

Undoubtedly, the curvature radius (R) of the arc 13a of the adjusting worm 10 is consistent with the radius of the milling cutter (not shown). Using milling cutters of different radii to mill the lateral ends of the tooth 13 in adjusting worms 10 of the same dimension will result in arcs 13a having different degrees of inclination. FIGS. 4 and 5 show two adjusting worms 10′ and 10″ which have the same dimension but teeth 13′, 13″ thereon are milled by milling cutters (not shown) of different radii. FIG. 4 is a side view of the adjusting worm 10′ having the tooth 13′ which is formed using a milling cutter of a smaller radius. The angle α′ of elevation between the bottom end of a arc 13a′ and a core 11′ is relatively larger. FIG. 5 is a side view of the adjusting worm 10″ with the tooth 13″ which is formed by a milling cutter of a larger radius. In this case, the angle α″ is relatively smaller. By comparing the two arcs 13a′, 13a″ of the adjusting worms 10′, 10″ in FIGS. 4 and 5 respectively, it can be seen that where the larger angle α′ of elevation (in FIG. 4) had a relatively smaller included angle β′ between the arcs 13a′ and the top end of the tooth 13′. On the other hand, where the smaller angle α″ of elevation (in FIG. 5) of the tooth 13″ had a relatively larger included angle β″. The adjusting worm 10′ in FIG. 4 with the smaller included angle β′ needs a fillet 13b′ of a relatively larger curvature radius r′, so that the adjusting worm 10′ can have a preferred feel to the touch when in use. However, the adjusting worm 10″ shown in FIG. 5 with a larger included angle β″ only needs a fillet 13b″ of a relatively smaller curvature radius r″.

It is obvious, if a milling cutter is used to mill teeth 13 of adjusting worms 10 of different dimensions, the arcs 13a of different inclinations will be obtained, and the curvature radius (r) of the angle α of elevation, include angle β and the fillet 13b will fall in different combination ranges. Hence, it can be seen that there is some kind of relationship among the dimension (D) of the adjusting worm 10, the curvature radius (R) of the arcs 13a and the curvature radius (r) of the fillets 13b.

Furthermore, there is a minor issue regarding the arcs 13a and fillets 13b of the adjusting worm according to the present invention. That is, the curvature radii (R,r) of the arcs 13a and the fillets 13b will affect the appearance of the worm when too large or too small.

Therefore, in consideration of the issues discussed above, the inventor has proposed the following table, which sets forth the dimensions of adjusting worms of the present invention:

| Wrench | Outer diameter of | | Radius | |
|---|---|---|---|---|
| dimension | adjusting worm* | Radius of arc | of fillet | |
| inch | (D, mm) | (R, mm) | (r, mm) | r/R |
| 4 | 7.0˜11.0 | 2.25˜15.0 | 0.84˜2.25 | 1˜0.056 |
| 6 | 8.0˜12.5 | 2.7˜17.0 | 0.85˜2.35 | 0.85˜0.050 |
| 8 | 11.0˜15.0 | 3.5˜20.4 | 0.90˜2.42 | 0.68˜0.044 |
| 10 | 13.0˜17.0 | 4.2˜23.1 | 0.9˜2.48 | 0.57˜0.039 |
| 12 | 15.0˜20.0 | 4.8˜27.2 | 0.95˜2.52 | 0.52˜0.035 |
| 15 | 18.0˜23.0 | 5.7˜31.3 | 1.00˜2.60 | 0.46˜0.032 |
| 18 | 20.0˜26.0 | 6.4˜35.4 | 1.00˜2.65 | 0.42˜0.029 |
| 24 | 24.0˜30.0 | 7.7˜40.8 | 1.02˜2.73 | 0.35˜0.025 |

*In the ISO or ASME specification for the manufacture of adjustable wrenches, the ranges of outer diameters of adjusting worms applicable for wrenches of different sizes are not specified. Therefore, the outer diameters of adjusting worms set forth in the table are possible ranges set according to the inventor's actual practice in manufacture.

In today's design concept, designing a convenient and comfortable operating interface is the goal every designers working at. The inventor has, from many years of experience in the manufacturing of wrenches, discovered that, in the conventional adjustable wrenches and pipe wrenches, the two sharp corners of the tooth of the adjusting worm will give the operator who is turning the adjusting worm a prickly feel. The present invention is to solve this problem of conventional wrenches, which has been disregarded by manufacturers.

What is claimed is:

1. An adjusting worm, which is mounted on a wrench, comprising: a substantially tubular core, which is centrally formed with a hole; a tooth, spirally extending on said core; said tooth having two lateral ends respectively having substantially inwardly recessed arcs, junctures between said two arcs and top end of said tooth respectively forming fillets.

2. The adjusting worm as defined in claim 1, wherein the value of ratio between the radius of said arc of said tooth and the radius of said fillet is in the range of 1˜0.025.

3. The adjusting worm as defined in claim 1, wherein the outer diameter of said adjusting worm is in the range of 7.0 mm˜1.0 mm, the curvature radii of said two arcs are in the range of 2.25 mm˜15.0 mm, and the curvature radii of said two fillets are in the range of 0.84 mm˜2.25 mm.

4. The adjusting worm as defined in claim 1, wherein the outer diameter of said adjusting worm is in the range of 8.0 mm˜12.5 mm, the curvature radii of said two arcs are in the range of 2.7 mm˜17.0 mm, and the curvature radii of said two fillets are in the range of 0. 85 mm˜2.35 mm.

5. The adjusting worm as defined in claim 1, wherein the outer diameter of said adjusting worm is in the range of 11.0 mm˜15.0 mm, the curvature radii of said two arcs are in the range of 3.5 mm˜20.4 mm, and the curvature radii of said two fillets are in the range of 0.90 mm˜2.42 mm.

6. The adjusting worm as defined in claim 1, wherein the outer diameter of said adjusting worm is in the range of 13.0 mm˜17.0 mm, the curvature radii of said two arcs are in the range of 4.2 mm˜23.1 mm, and the curvature radii of said two fillets are in the range of 0.92 mm˜2.48 mm.

7. The adjusting worm as defined in claim 1, wherein the outer diameter of said adjusting worm is in the range of 15.0 mm˜20.0 mm, the curvature radii of said two arcs are in the range of 4.8 mm˜27.2 mm, and the curvature radii of said two fillets are in the range of 0.95 mm˜2.52 mm.

8. The adjusting worm as defined in claim 1, wherein the outer diameter of said adjusting worm is in the range of 18.0 mm˜23.0 mm, the curvature radii of said two arcs are in the range of 5.7 mm˜31.3 mm, and the curvature radii of said two fillets are in the range of 1.0 mm˜2.60 mm.

9. The adjusting worm as defined in claim 1, wherein the outer diameter of said adjusting worm is in the range of 20.0 mm˜26.0 mm, the curvature radii of said two arcs are in the range of 6.4 mm˜35.4 mm, and the curvature radii of said two fillets are in the range of 1.00 mm˜2.65 mm.

10. The adjusting worm as defined in claim 1, wherein the outer diameter of said adjusting worm is in the range of 24.0 mm˜30.0 mm, the curvature radii of said two arcs are in the range of 7.7 mm˜40.8 mm, and the curvature radii of said two fillets are in the range of 1.02 mm˜2.73 mm.
